(19) United States
(12) Patent Application Publication
(10) Pub. No.: US 2025/0346020 A1
(43) Pub. Date: Nov. 13, 2025

(54) LAMINATE AND DISPLAY

(71) Applicant: KANEKA CORPORATION, Osaka (JP)

(72) Inventors: Yusuke Taguchi, Osaka (JP); Jun Kamite, Otsu-shi (JP)

(73) Assignee: KANEKA CORPORATION, Osaka (JP)

(21) Appl. No.: 19/279,171

(22) Filed: Jul. 24, 2025

Related U.S. Application Data
(63) Continuation of application No. PCT/JP2024/001665, filed on Jan. 22, 2024.

(30) Foreign Application Priority Data
Jan. 26, 2023 (JP) 2023-010195

(51) Int. Cl. B32B 17/10; B32B 7/12; B32B 27/30; G09F 9/30

(52) U.S. Cl. CPC B32B 17/10; B32B 7/12; B32B 27/308; G09F 9/301; B32B 2255/10; B32B 2255/26; B32B 2307/412; B32B 2307/7376; B32B 2379/08; B32B 2457/20

(57) ABSTRACT

A laminate including a thin glass having a thickness of 100 μm or less and a transparent resin film bonded to one principal surface of the thin glass is disclosed. A hard coat layer may be provided on one principal surface of the transparent resin film. The transparent resin film contains a polyimide-based resin and a solvent-soluble resin other than the polyimide-based resin. The solvent-soluble resin may be an acryl-based resin. The laminate exhibits excellent transparency and dent recoverability, and thus is suitable as a cover window material for a display.

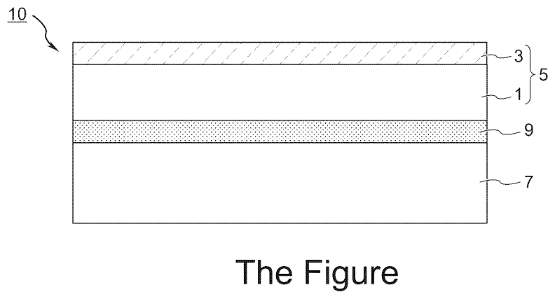

### TECHNICAL FIELD

One or more embodiments of the present invention relate to a laminate in which a thin glass and a transparent resin film are bonded to each other, and a display including the laminate.

### BACKGROUND

A bendable thin glass is used as a cover window material that is disposed on a surface of a flexible display. Glass has high optical transparency and the visibility of a display device is improved thereby, but there is a concern that thin glass having a small thickness is likely to easily break due to a strong impact or a crack at an edge.

For the purpose of improving impact resistance and preventing scattering of glass, it has been proposed to use a laminate in which a transparent resin film is bonded to a surface of a thin glass, as a cover window material. For example, Patent Document 1 proposes use of a laminate in which a thin glass and a transparent polyimide film with a hard coat are bonded together, as a cover window material of a flexible display. Since a transparent polyimide film has good mechanical properties, a laminate in which a thin glass and the transparent polyimide film are bonded together is superior in impact resistance, has a function of preventing glass scattering, and has a high function of display protection.

### Patent Document

Patent Document 1: WO 2021/177288 A

Polyimide has a high refractive index, and thus has a large amount of light reflection (a high reflectance) due to a difference in refractive index from an air interface or an interface with another member, resulting in a low total light transmittance. Therefore, when a laminate in which a thin glass and a transparent polyimide film are bonded together is used as a cover window material, the use of the laminate may cause a decrease in the luminance of a display. In addition, since the absorption band overlaps a short wavelength region of visible light, the transparent polyimide is slightly colored in yellow, and may affect the hue (color tone) of the display.

A transparent polyimide film is superior in mechanical strength, and a laminate in which a thin glass and a transparent polyimide film are bonded together is less likely to generate a dent due to a pressing pressure by a nail, a touch pen, or the like or due to sliding. However, once a dent occurs, the dent is difficult to recover and remains over time, which adversely affects the visibility of the display. Therefore, there is a demand for a cover window material in which even when a dent is generated by an external force, the dent recovers overtime.

### SUMMARY

In view of the above, one or more embodiments of the present invention are to provide a cover window material having superior transparency and dent recoverability.

The laminate of one or more embodiments of the present invention includes a thin glass having a thickness of 100 μm or less and a transparent resin film bonded to one principal surface of the thin glass. The transparent resin film contains a polyimide-based resin and a solvent-soluble resin other than the polyimide-based resin. The refractive index of the transparent resin film may be 1.600 or less.

As the solvent-soluble resin, acryl-based resins are preferable, and of these resins, one containing methyl methacrylate as a main component is preferable.

The polyimide-based resin is a polyimide or a polyamideimide, and the resin includes a structure derived from a tetracarboxylic dianhydride and a structure derived from a diamine. The polyimide-based resin may be a polyimide. The polyimide-based resin may be one in which a fluorine-containing aromatic tetracarboxylic dianhydride and an alicyclic tetracarboxylic dianhydride are contained as the tetracarboxylic dianhydride, and a fluorine-containing diamine is contained as the diamine.

The transparent resin film may be a stretched film. The thickness of the transparent resin film may be 20 to 55 μm. The total light transmittance of the transparent resin film may be 90.5% or more.

A hard coat layer may be provided on a principal surface of the transparent resin film. That is, the laminate of one or more embodiments of the present invention may be one in which a transparent film with a hard coat layer provided on a principal surface of a transparent resin film (hard coat film) is bonded to a thin glass. Examples of the material of the hard coat layer include an acryl-based hard coat material and a siloxane-based hard coat material. The thickness of the hard coat layer may be 1 to 50 m.

The laminate of one or more embodiments of the present invention is suitably used as a cover window material for a display because the laminate has a high total light transmittance and dent recoverability.

### BRIEF DESCRIPTION OF THE DRAWING

The FIGURE is a sectional view of a laminate of one or more embodiments.

### DETAILED DESCRIPTION

The FIGURE is a sectional view of a laminate according to one or more embodiments of the present invention. The laminate 10 includes a transparent film 5 on one principal surface of a thin glass 7. The thin glass 7 and the transparent film 5 may be in direct contact, or may be bonded together with an appropriate transparent adhesive layer 9 interposed therebetween. The transparent film 5 includes a transparent resin film 1. The transparent film 5 may be a hard coat film having a hard coat layer 3 on one surface of the transparent resin film 1.

### [Thin Glass]

The thin glass 7 is a glass substrate (glass film) having a thickness of 100 μm or less. The thin glass film 7 has superior mechanical strength and transparency peculiar to glass, and has bendability because of its small thickness. Although the glass material constituting the thin glass is not particularly limited, a chemically strengthened glass is preferable. Examples of the glass constituting the chemically strengthened glass include aluminosilicate glass, soda lime glass, borosilicate glass, lead glass, alkali barium glass, and aluminoborosilicate glass.

The chemically strengthened glass is a glass having an improved mechanical strength brought by partially exchanging ion species constituting the glass in the vicinity of the surface. By exchanging the ion species, a reinforcing layer having compressive stress is formed in the vicinity of the surface of the glass, so that a thin glass which is hardly broken and is superior in mechanical properties is obtained. It is preferable that the chemical strengthening is performed not only on the surface of the thin glass but also on the end surface, from the viewpoint of resistance to breaking.

From the viewpoint of imparting bendability and securing bending resistance, the thickness of the thin glass may be 100 μm or less, 60 μm or less, 55 μm or less, 50 μm or less, 40 μm or less, 35 μm or less, or 30 μm or less. From the viewpoint of securing mechanical properties, the thickness of the thin glass may be 5 μm or more, 10 μm or more, 15 μm or more, 20 μm or more, or 25 m or more.

The elastic modulus of the thin glass may be 50 GPa or more, 60 GPa or more, or 70 GPa or more. When the elastic modulus of the thin glass is high, the impact resistance of the laminate tends to be improved.

### [Transparent Film]

The transparent film 5 to be bonded onto the thin glass 7 includes a transparent resin film 1. The transparent film 5 may be one made of the transparent resin film 1, or may be one having a functional layer such as the hard coat layer 3 on the transparent resin film 1.

### [Transparent Resin Film]

The transparent resin film 1 contains one or more polyimide-based resins selected from the group consisting of a polyimide and a polyamideimide, and a solvent-soluble resin other than the polyimide-based resins (hereinafter sometimes referred to as “OTHER resin”). When the transparent resin film 1 contains polyimide-based resins and the OTHER resin, transparency and dent recoverability tend to be improved.

### <Polyimide-Based Resin>

The polyimide is obtained by cyclodehydrating a polyamic acid obtained by a reaction of a tetracarboxylic acid dianhydride (hereinafter, it may be referred to as “acid dianhydride”) with a diamine. The polyamideimide is obtained by replacing a part of the tetracarboxylic dianhydride of the polyimide with a dicarboxylic acid derivative such as dicarboxylic acid dichloride. As the polyimide-based resin, a polyimide and a polyamideimide may be used in combination. From the viewpoint of compatibility and the like with the OTHER resin, a polyimide may be preferable as the polyimide-based resin.

### (Tetracarboxylic Dianhydride)

The polyimide-based resin used in one or more embodiments may contain an alicyclic tetracarboxylic dianhydride as an acid dianhydride component. Due to the fact that the acid dianhydride component has an alicyclic structure, the compatibility between the polyimide-based resin and the OTHER resin such as an acryl-based resin tends to be improved. The alicyclic tetracarboxylic dianhydride is only required to have at least one alicyclic structure, and may have both an alicyclic ring and an aromatic ring in one molecule. The alicyclic ring may be polycyclic, or may have a spiro structure.

Examples of the alicyclic tetracarboxylic dianhydride include 1,2,3,4-cyclobutanetetracarboxylic dianhydride, 1,2,3,4-cyclopentanetetracarboxylic dianhydride, 1,3-dimethylcyclobutane-1,2,3,4-tetracarboxylic dianhydride, 1,2,3,4-tetramethyl-1,2,3,4-cyclobutanetetracarboxylic dianhydride, 1,2,4,5-cyclohexanetetracarboxylic dianhydride, 1,2,3,4-butanetetracarboxylic dianhydride, meso-butane-1,2,3,4-tetracarboxylic dianhydride, 1,1′-bicyclohexane-3,3′,4,4′ tetracarboxylic-3,4:3′,4′-dianhydride, norbornane-2-spiro-α-cyclopentanone-α′-spiro-2″-norbornane-5,5″,6,6″-tetracarboxylic dianhydride, 2,2′-binorbomane-5,5′,6,6′ tetracarboxylic dianhydride, 3-(carboxymethyl)-1,2,4-cyclopentanetricarboxylic 1,4:2,3-dianhydride, bicyclo[2.2.2]octa-7-ene-2,3,5,6-tetracarboxylic dianhydride, 4-(2,5-dioxotetrahydrofuran-3-yl)-1,2,3,4-tetrahydronaphthalene-1,2-dicarboxylic anhydride, cyclohexane-1,4-diylbis(methylene)bis(1,3-dioxo-1,3-dihydroisobenzofuran-5-carboxylate), 5-(2,5-dioxotetrahydrofuryl)-3-methyl-3-cyclohexene-1,2-dicarboxylic anhydride, 5,5′-[cyclohexylidenebis(4,1-phenyleneoxy)]bis-1,3-isobenzofurandione, 5-isobenzofurancarboxylic acid,1,3-dihydro-1,3-dioxo-,5,5′-[1,4-cyclohexanediylbis(methylene)]ester, bicyclo[2.2.1]heptane-2,3,5,6-tetracarboxylic dianhydride, bicyclo[2.2.2]octane-2,3,5,6-tetracarboxylic dianhydride, 3,5,6-tricarboxynorbomane-2-acetic 2,3:5,6-dianhydride, decahydro-1,4,5,8-dimethanonaphthalene-2,3,6,7-tetracarboxylic dianhydride, tricyclo[6.4.0.0 (2,7)]dodecane-1,8:2,7-tetracarboxylic dianhydride, octahydro-1H,3H,8H,10H-biphenyleno[4a,4bc:8a,8b-c′]difuran-1,3,8,10-tetraone, ethylene glycolbis(hydrogenated trimellitic anhydride)ester, and decahydro[2]benzopyrano[6,5,4,-def][2]benzopyrano-1,3,6,8-tetarone.

Among the alicyclic tetracarboxylic dianhydrides, from the viewpoint of the transparency and mechanical strength ofthe polyimide-based resin, 1,2,3,4-cyclobutanetetracarboxylic dianhydride (CBDA), 1,2,3,4-cyclopentanetetracarboxylic dianhydride(CPDA), 1,2,4,5-cyclohexanetetracarboxylic dianhydride (H-PMDA) or 1,1′-bicyclohexane-3,3′,4,4′-tetracarboxylic acid-3,4:3′,4′-dianhydride (H-BPDA) is preferable, and 1,2,3,4-cyclobutanetetracarboxylic dianhydride is particularly preferable.

From the viewpoint of improving the compatibility between the polyimide-based resin and the OTHER resin, the content of the alicyclic tetracarboxylic dianhydride with respect to 100 mol % of all acid dianhydride components may be 1 mol % or more, 3 mol % or more, 5 mol % or more, 6 mol % or more, 7 mol % or more, 8 mol % or more, 9 mol % or more, 10 mol % or more, 12 mol % or more, or 15 mol % or more. The amount of the alicyclic tetracarboxylic dianhydride required for imparting the compatibility with the OTHER resin may vary depending on, for example, the type of the OTHER resin and the type of the alicyclic tetracarboxylic dianhydride. For example, when the alicyclic tetracarboxylic dianhydride is 1,2,3,4-cyclobutanetetracarboxylic dianhydride (CBDA), the content of CBDA with respect to 100 mol % of all acid dianhydride components may be 6 mol % or more, 8 mol % or more, or 10 mol % or more.

From the viewpoint of securing the solubility of the polyimide-based resin in an organic solvent, the content of the alicyclic tetracarboxylic dianhydride with respect to 100 mol % of all acid dianhydride components may be 80 mol % or less, 78 mol % or less, 76 mol % or less, 74 mol % or less, 72 mol % or less, mol % or less, 65 mol % or less, 60 mol % or less, 55 mol % or less, or 50 mol % or less. To make the polyimide-based resin soluble in a low-boiling-point halogen-based solvent such as methylene chloride, the content of the alicyclic tetracarboxylic dianhydride may be 45 mol % or less, 40 mol % or less, or 35 mol % or less.

From the viewpoint of making the polyimide-based resin soluble in an organic solvent, it is preferable to contain a fluorine-containing aromatic tetracarboxylic dianhydride or/and a bis(trimellitic anhydride) ester as the acid dianhydride component in addition to the alicyclic tetracarboxylic dianhydride.

Examples of the fluorine-containing aromatic tetracarboxylic dianhydride include 2,2-bis(3,4-dicarboxyphenyl)-1,1,1,3,3,3-hexafluoropropanoic dianhydride and 2,2-bis{4-[4-(1,2-dicarboxy)phenoxy]phenyl}-1,1,1,3,3,3-hexafluoropropanoic dianhydride.

Examples of the bis(trimellitic anhydride) ester include bis(1,3-dioxo-1,3-dihydroisobenzofuran-5-carboxylic acid)-2,2′,3,3′,5,5′-hexamethylbiphenyl-4,4′-diyl (abbreviation: TAHMIIBP).

From the viewpoint of making the polyimide-based resin soluble in an organic solvent, the total content of the fluorine-containing aromatic tetracarboxylic dianhydride and the bis(trimellitic anhydride) ester with respect to 100 mol % of the total amount of the acid dianhydride components may be 15 mol % or more, 20 mol % or more, 25 mol % or more, 30 mol % or more, 35 mol % or more, 40 mol % or more, 45 mol % or more, or 50 mol % or more. The total content of the fluorine-containing aromatic tetracarboxylic dianhydride and the bis(trimellitic anhydride) ester with respect to 100 mol % of the total amount of the acid dianhydride components may be 99 mol % or less, 95 mol % or less, 90 mol % or less, 85 mol % or less, 80 mol % or less, 75 mol % or less, or 70 mol % or less.

From the viewpoint of obtaining a polyimide-based resin having both solubility in an organic solvent and compatibility with the OTHER resin, the total content of the alicyclic tetracarboxylic dianhydride, the fluorine-containing aromatic tetracarboxylic dianhydride, and the bis(trimellitic anhydride) ester with respect to 100 mol % of the total amount of the acid dianhydride components may be mol % or more, 60 mol % or more, 65 mol % or more, 70 mol % or more, 75 mol % or more, 80 mol % or more, 85 mol % or more, 90 mol % or more, or 95 mol % or more.

The polyimide-based resin may contain, as the acid dianhydride component, an acid dianhydride other than the alicyclic tetracarboxylic dianhydride, the fluorine-containing aromatic tetracarboxylic dianhydride, and the bis(trimellitic anhydride) ester. Examples of acid dianhydrides other than those described above include ethylenetetracarboxylic dianhydride, butanetetracarboxylic dianhydride, 3,3′,4,4′-benzophenonetetracarboxylic anhydride, 2,2′,3,3′-benzophenonetetracarboxylic anhydride, 2,2′,3,3′-biphenyltetracarboxylic dianhydride, pyromellitic dianhydride, 3,3′,4,4′-biphenyltetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl) ether dianhydride, bis(3,4-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 9,9-bis(3,4-dicarboxyphenyl)fluorene dianhydride, 1,3-bis[(3,4-dicarboxy)benzoyl]benzene dianhydride, 1,4-bis[(3,4-dicarboxy)benzoyl]benzene dianhydride, 2,2-bis{4-[4-(1,2-dicarboxy)phenoxy]phenyl}propane dianhydride, 2,2-bis{4[4-(3,4-dicarboxy)phenoxy]phenyl}propane dianhydride, 2,2-bis{4-[3-(1,2-dicarboxy)phenoxy]phenyl}propane dianhydride, bis{4-[4-(1,2-dicarboxy)phenoxy]phenyl}ketone dianhydride, bis{4-[3-(1,2-dicarboxy)phenoxy]phenyl}ketone dianhydride, 4,4′-bis[4-(1,2-dicarboxy)phenoxy]biphenyl dianhydride, 4,4′-bis[3-(1,2-dicarboxy)phenoxy]biphenyl dianhydride, bis{4-[4-(1,2-dicarboxy)phenoxy]phenyl}ketone dianhydride, bis{4-[3-(1,2-dicarboxy)phenoxy]phenyl}ketone dianhydride, bis{4-[4-(1,2-dicarboxy)phenoxy]phenyl}sulfone dianhydride, bis{4-[3-(1,2-dicarboxy)phenoxy]phenyl}sulfone dianhydride, bis{4-[4-(1,2-dicarboxy)phenoxy]phenyl}sulfide dianhydride, bis{4-[3-(1,2-dicarboxy)phenoxy]phenyl}sulfide dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 1,2,3,4-benzenetetracarboxylic dianhydride, 3,4,9,10-perylenetetracarboxylic dianhydride, 2,3,6,7-anthracenetetracarboxylic dianhydride, 1,2,7,8-phenyltetracarboxylic dianhydride, and bis(1,3-dihydro-1,3-dioxo-5-isobenzofurancarboxylic acid)-1,4-phenylene ester.

### (Dicarboxylic Acid)

As described above, the polyimide-based resin may be a polyamideimide in which a part of the tetracarboxylic acid dianhydride component is replaced with a dicarboxylic acid derivative. Examples of the dicarboxylic acid include: aliphatic dicarboxylic acids such as adipic acid, suberic acid, azelaic acid, sebacic acid, and dodecanedioic acid; aromatic dicarboxylic acids such as terephthalic acid, isophthalic acid, 2-chloroterephthalic acid, 2-methylterephthalic acid, 5-methylisophthalic acid, 2,6-naphthalenedicarboxylic acid, 4,4′-oxybisbenzoic acid, 4,4′-biphenyldicarboxylic acid, and 2-fluoroterephthalic acid; alicyclic dicarboxylic acids such as 1,4-cyclohexanedicarboxylic acid, 1,3-cyclohexanedicarboxylic acid, 1,2-hexahydroterephthalic acid, hexahydroisophthalic acid, 1,3-cyclopentanedicarboxylic acid, and bi(cyclohexyl)-4,4′-dicarboxylic acid; and heterocyclic dicarboxylic acids such as 2,5-thiophene dicarboxylic acid and 2,5-furandicarboxylic acid.

From the viewpoint of the solubility of the polyamideimide and compatibility with the OTHER resin, the dicarboxylic acid may be an aromatic dicarboxylic acid or an alicyclic dicarboxylic acid, or an aromatic dicarboxylic acid. Among aromatic dicarboxylic acids, terephthalic acid, isophthalic acid, 4,4′-biphenyl dicarboxylic acid, and 4,4′-oxybisbenzoic acid are preferable, and of these, terephthalic acid and isophthalic acid are preferable, and terephthalic acid is particularly preferable.

As the dicarboxylic acid derivative used as a raw material monomer of the polyamideimide, dicarboxylic acid derivatives such as dicarboxylic acid dichloride, dicarboxylic acid ester, and dicarboxylic acid anhydride are used. Of these, a dicarboxylic acid dichloride is preferable because of its high reactivity.

From the viewpoint of the solubility of the polyamideimide and compatibility with the OTHER resin, the proportion of the dicarboxylic acid derivative to the total of the tetracarboxylic acid dianhydride and the dicarboxylic acid derivative may be 40 mol % or less, 35 mol % or less, or 30 mol % or less. The polyimide-based resin may be a polyimide in which the proportion of the dicarboxylic acid derivative is 0 (that is, containing no structure derived from the dicarboxylic acid derivative).

### (Diamine)

The diamine component of the polyimide-based resin used in one or more embodiments is not particularly limited. From the viewpoint of solubility, the diamine of the polyimide-based resin may have one or more selected from the group consisting of a fluorine group, a trifluoromethyl group, a sulfone group, a fluorene structure, and an alicyclic structure. Of these, from the viewpoint of achieving both the solubility and the transparency of the polyimide-based resin, the polyimide-based resin may contain a fluorine-containing diamine such as fluoroalkyl-substituted benzidine as the diamine component.

Examples of the fluoroalkyl-substituted benzidine includes fluorine-containing diamine, include 2-(trifluoromethyl)benzidine, 3-(trifluoromethyl)benzidine, 2,3-bis(trifluoromethyl)benzidine, 2,5-bis(trifluoromethyl)benzidine, 2,6-bis(trifluoromethyl)benzidine, 2,3,5-tris(trifluoromethyl)benzidine, 2,3,6-tris(trifluoromethyl)benzidine, 2,3,5,6-tetrakis(trifluoromethyl)benzidine, 2,2′-bis(trifluoromethyl)benzidine, 3,3′-bis(trifluoromethyl)benzidine, 2,3′-bis(trifluoromethyl)benzidine, 2,2′,3-bis(trifluoromethyl)benzidine, 2,3,3′-tris(trifluoromethyl)benzidine, 2,2′,5-tris(trifluoromethyl)benzidine, 2,2′,6-tris(trifluoromethyl)benzidine, 2,3′,5-tris(trifluoromethyl)benzidine, 2,3′,6,-tris(trifluoromethyl)benzidine, 2,2′,3,3′-tetrakis (trifluoromethyl)benzidine, 2,2′,5,5′-tetrakis(trifluoromethyl)benzidine, and 2,2′,6,6′-tetrakis(trifluoromethyl)benzidine.

Of these, a fluoroalkyl-substituted benzidine having a fluoroalkyl group at the 2-position of biphenyl is preferable, and 2,2′-bis(trifluoromethyl)benzidine (hereinafter, referred to as “TFMB”) is particularly preferable. When fluoroalkyl groups are present at the 2-position and 2′-position of biphenyl, the n-electron density decreases because of the electron-attracting property of the fluoroalkyl group, and a bond between two benzene rings of biphenyl is twisted by steric hindrance of the fluoroalkyl group, leading to a decrease in planarity of the n-conjugate. Thus, the absorption edge wavelength shifts to a short wave, and thus coloring of the polyimide-based resin can be suppressed.

The content of the fluoroalkyl-substituted benzidine with respect to 100 mol % of the total amount of the diamine components may be 50 mol % or more, 60 mol % or more, 70 mol % or more, 80 mol % or more, 85 mol % or more, or 90 mol % or more. A large content of the fluoroalkyl-substituted benzidine tends to lead to suppression of coloring of the film and enhancement of mechanical strength in terms of pencil hardness, elastic modulus, and the like.

The polyimide-based resin may contain a diamine other than the fluoroalkyl-substituted benzidine as the diamine component. Examples of the diamine other than the fluoroalkyl-substituted benzidine include p-phenylenediamine, m-phenylenediamine, o-phenylenediamine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenylsulfone, 3,4′-diaminodiphenylsulfone, 4,4′-diaminodiphenylsulfone, 9,9-bis(4-aminophenyl)fluorene, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl)propane, 2,2-di(4-aminophenyl)propane, 2-(3-aminophenyl)-2-(4-aminophenyl)propane, 1,1-di(3-aminophenyl)-1-phenylethane, 1,1-di(4-aminophenyl)-1-phenylethane, 1-(3-aminophenyl)-1-(4-aminophenyl)-1-phenylethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3-bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl)benzene, 2,6-bis(3-aminophenoxy)benzonitrile, 2,6-bis(3-aminophenoxy)pyridine, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 2,2-bis[4-(3-aminophenoxy)phenyl]propane, 2,2-bis[4-(4-aminophenoxy)phenyl]propane, 1,3-bis[4-(3-aminophenoxy)benzoyl]benzene, 1,3-bis[4-(4-aminophenoxy)benzoyl]benzene, 1,4-bis[4-(3-aminophenoxy)benzoyl]benzene, 1,4-bis[4-(4-aminophenoxy)benzoyl]benzene, 1,3-bis[4-(3-aminophenoxy)-α,α-dimethylbenzyl]benzene, 1,3-bis[4-(4-aminophenoxy)-α,α-dimethylbenzyl]benzene, 1,4-bis[4-(3-aminophenoxy)-α,α-dimethylbenzyl]benzene, 1,4-bis[4-(4-aminophenoxy)-α,α-dimethylbenzyl]benzene, 4,4′-bis[4-(4-aminophenoxy)benzoyl]diphenyl ether, 4,4′-bis[4-(4-amino-α,α-dimethylbenzyl)phenoxy]benzophenone, 4,4′-bis[4-(4-amino-α,α-dimethylbenzyl)phenoxy]diphenylsulfone, 4,4′-bis[4-(4-aminophenoxy)phenoxy]diphenylsulfone, 3,3′-diamino-4,4′-diphenoxybenzophenone, 3,3′-diamino-4,4′-dibiphenoxybenzophenone, 3,3′-diamino-4-phenoxybenzophenone, 3,3′-diamino-4-phenoxybenzophenone, 6,6′-bis(3-aminophenoxy)-3,3,3′,3′-tetramethyl-1,1′-spirobiindan, 6,6′-bis(4-aminophenoxy)-3,3,3′,3′-tetramethyl-1,1′-spirobiindan, 1,3-bis(3-aminopropyl)tetramethyldisiloxane, 1,3-bis(4-aminobutyl)tetramethyldisiloxane, α,ω-bis(3-aminopropyl)polydimethylsiloxane, α,ω-bis(3-aminobutyl)polydimethylsiloxane, bis(aminomethyl)ether, bis(2-aminoethyl)ether, bis(3-aminopropyl)ether, bis(2-aminomethoxy)ethyl]ether, bis[2-(2-aminoethoxy)ethyl]ether, bis[2-(3-aminoprotoxy)ethyl]ether, 1,2-bis(aminomethoxy)ethane, 1,2-bis(2-aminoethoxy)ethane, 1,2-bis[2-(aminomethoxy)ethoxy]ethane, 1,2-bis[2-(2-aminoethoxy)ethoxy]ethane, ethylene glycol bis(3-aminopropyl)ether, 1,3-di(2-aminoethyl)cyclohexane, 1,4-di(2-aminoethyl)cyclohexane, bis(4-aminocyclohexyl)methane, 2,6-bis(aminomethyl)bicyclo[2.2.1]heptane, 2,5-bis(aminomethyl)bicyclo[2.2.1]heptane, 1,4-diamino-2-fluorobenzene, 1,4-diamino-2,3-difluorobenzene, 1,4-diamino-2,5-difluorobenzene, 1,4-diamino-2,6-difluorobenzene, 1,4-diamino-2,3,5-trifluorobenzene, 1,4-diamino, 2,3,5,6-tetrafluorobenzene, 1,4-diamino-2-(trifluoromethyl)benzene, 1,4-diamino-2,3-bis(trifluoromethyl)benzene, 1,4-diamino-2,5-bis(trifluoromethyl)benzene, 1,4-diamino-2,6-bis(trifluoromethyl)benzene, 1,4-diamino-2,3,5-tris(trifluoromethyl)benzene, 1,4-diamino, 2,3,5,6-tetrakis(trifluoromethyl)benzene, 2,2′-dimethylbenzidine, 2-fluorobenzidine, 3-fluorobenzidine, 2,3-difluorobenzidine, 2,5-difluorobenzidine, 2,6-difluorobenzidine, 2,3,5-trifluorobenzidine, 2,3,6-trifluorobenzidine, 2,3,5,6-tetrafluorobenzidine, 2,2′-difluorobenzidine, 3,3′-difluorobenzidine, 2,3′-difluorobenzidine, 2,2′,3-trifluorobenzidine, 2,3,3′-trifluorobenzidine, 2,2′,5-trifluorobenzidine, 2,2′,6-trifluorobenzidine, 2,3′,5-trifluorobenzidine, 2,3′,6-trifluorobenzidine, 2,2′,3,3′-tetrafluorobenzidine, 2,2′,5,5′-tetrafluorobenzidine, 2,2′,6,6′-tetrafluorobenzidine, 2,2′,3,3′,6,6′-hexafluorobenzidine, and 2,2′,3,3′,5,5′,6,6′-octafluorobenzidine.

For example, by using diaminodiphenylsulfone as the diamine in addition to the fluoroalkyl-substituted benzidine, the solvent-solubility and transparency of the polyimide-based resin may be improved. Among the diaminodiphenylsulfones, 3,3′-diaminodiphenylsulfone (3,3′-DDS) and 4,4′-diaminodiphenylsulfone (4,4′-DDS) are preferable. 3,3′-DDS and 4,4′-DDS may be used in combination. The content of diaminodiphenylsulfone with respect to 100 mol % of all diamines may be 1 to 40 mol %, 3 to 30 mol %, or 5 to 25 mol %.

### (Preparation of Polyimide-Based Resin)

A polyamic acid as a polyimide precursor is obtained through the reaction between the acid dianhydride and the diamine, and the polyimide is obtained through cyclodehydration (imidization) of the polyamic acid. A method for preparing the polyamic acid is not particularly limited, and any known method can be used. For example, a polyamic acid solution is obtained by dissolving the diamine and the tetracarboxylic dianhydride in an organic solvent in substantially equimolar amounts (molar ratio of 90: 100 to 110:100) and stirring the mixture.

In preparation of the polyamideimide, a dicarboxylic acid or a derivative thereof (dicarboxylic acid dichloride, dicarboxylic acid anhydride, or the like) may be used as a monomer in addition to the diamine and the tetracarboxylic dianhydride. In this case, the amount of each monomer can be adjusted such that the total amount of the tetracarboxylic dianhydride and the dicarboxylic acid or a derivative thereof is substantially equimolar amount to the amount of the diamine.

As described above, the polyimide-based resin exhibits transparency, solubility in an organic solvent, and compatibility with OTHER resin, by adjusting its composition, i.e., the type and proportion of the acid dianhydride and the diamine.

The concentration of the polyamic acid solution may be typically 5 to 35 wt %, or 10 to 30 wt %.

When the concentration is within this range, the polyamic acid obtained through polymerization has an appropriate molecular weight, and the polyamic acid solution has an appropriate viscosity.

In the polymerization of the polyamic acid, a method is preferable in which the acid dianhydride is added to the diamine for suppressing ring opening of the acid dianhydride. When adding a plurality of types of diamine and a plurality of types of acid dianhydride are added, they may be added at one time, or may be added in a plurality of times. Various physical properties of the polyimide-based resin can also be controlled by adjusting the order of addition of monomers.

The organic solvent used for polymerization of the polyamic acid is not particularly limited as long as it does not react with the diamine or the acid dianhydride but can dissolve the polyamic acid. Examples of the organic solvent include urea-based solvents such as methylurea and N,N-dimethylethylurea; sulfoxide or sulfone-based solvents such as dimethyl sulfoxide, diphenylsulfone and tetramethylsulfone; amide-based solvents such as N,N-dimethyacetamide (DMAc), N,N-dimethylformamide (DMF), N,N-diethylacetamide, N-methyl-2-pyrrolidone (NMP), 7-butyrolactone and hexamethylphosphoric triamide; alkyl halide-based solvents such as chloroform and methylene chloride; aromatic hydrocarbon-based solvents such as benzene and toluene; and ether-based solvents such as tetrahydrofuran, 1,3-dioxolane, 1,4-dioxane, dimethyl ether, diethyl ether and p-cresol methyl ether. These solvents are typically used singly, or as necessary, two or more thereof are used in combination as appropriate. From the viewpoint of the solubility and polymerization reactivity of the polyamic acid, DMAc, DMF, NMP and the like may be used.

A polyimide-based resin can be obtained through cyclodehydration of the polyamic acid. Examples of the method for preparing the polyimide-based resin from a polyamic acid solution include a method in which a dehydrating agent, an imidization catalyst and the like are added to a polyamic acid solution to advance imidization in the solution. The polyamic acid solution may be heated to accelerate the progress of imidization. By mixing a poor solvent with a solution containing the polyimide-based resin generated through imidization of the polyamic acid, a polyimide-based resin is precipitated as a solid. By isolating the polyimide-based resin as a solid substance, impurities generated during synthesis of the polyamic acid, and the residual dehydration agent and the imidization catalyst and the like can be washed and removed with the poor solvent, and thus, it is possible to prevent coloring of the polyimide-based resin and an increase in yellowness index. By isolating the polyimide-based resin as a solid, a solvent suitable for forming a film, such as a low-boiling-point solvent, can be applied in preparation of a solution for producing a film.

The molecular weight (weight-average molecular weight in terms of polyethylene oxide which is measured by gel permeation chromatography (GPC)) of the polyimide-based resin may be 10,000 to 300,000, 20,000 to 250,000, or 40,000 to 200,000. An excessively small molecular weight may result in insufficient strength of the film. An excessively large molecular weight may result in poor compatibility with the OTHER resin.

The polyimide-based resin may be soluble in a low-boiling-point solvent such as a ketone-based solvent or a halogenated alkyl-based solvent. The phrase “the polyimide-based resin exhibits solubility in a solvent” means that the polyimide-based resin is dissolved at a concentration of 5 wt % or more. In one or more embodiments, the polyimide-based resin exhibits solubility in methylene chloride. Methylene chloride has a low boiling point, and thus it is easy to remove the residual solvent at the time of producing a film. Thus, the use of a polyimide-based resin soluble in methylene chloride can be expected to improve productivity of the film.

From the viewpoint of thermal stability and light stability of the transparent resin film, the polyimide-based resin may have low reactivity. The acid value of the polyimide-based resin may be 0.4 mmol/g or less, 0.3 mmol/g or less, or 0.2 mmol/g or less. The acid value of the polyimide may be 0.1 mmol/g or less, 0.05 mmol/g or less, or 0.03 mmol/g or less. From the viewpoint of reducing the acid value, the polyimide-based resin may have a high imidization ratio. A small acid value tends to lead to enhancement of the stability of the polyimide-based resin and improvement in compatibility with the OTHER resin.

### <OTHER Resin>

As described above, in addition to the polyimide-based resin, the transparent resin film 1 contains a resin other than the polyimide-based resin (“OTHER resin”). The OTHER resin is not particularly limited as long as it is soluble in an organic resin and can be mixed with the polyimide-based resin to form a transparent film, and examples thereof include those capable of being compatible with the polyimide-based resin and those forming a microphase separation structure such as a sea-island structure, a cylinder structure, or a lamellar structure. Of these, the OTHER resin may be compatible with the polyimide-based resin. When the polyimide-based resin and the OTHER resin are compatible with each other, there is a tendency that transparency is high, and mechanical properties such as elastic modulus and pencil hardness are excellent regardless of processing conditions of the film.

The OTHER resin may be a transparent resin having a refractive index lower than that of the polyimide-based resin. The refractive index of the OTHER resin may be 1.600 or less, 1.550 or less, 1.520 or less, or 1.500 or less. Due to the fact that the OTHER resin has a refractive index lower than that of the polyimide-based resin, the transparent resin film containing the polyimide-based resin and the OTHER resin has a refractive index lower than that of a film containing the polyimide-based resin alone, and has small reflection at the interface, so that the total light transmittance tends to be high.

Examples of the OTHER resin include an acryl-based resin, a polycarbonate-based resin, a polyester-based resin, a polyamide-based resin, a polyether-based resin, a cellulose-based resin, a silicone-based resin, and a cyclic olefin-based resin. A plurality of types of these resins may be used. From the viewpoint of high compatibility with the polyimide-based resin, preferable examples of the OTHER resin include an acryl-based resin, a polycarbonate-based resin, and a polyester-based resin having a fluorene structure. Of these, an acryl-based resin is particularly preferable because it exhibits high compatibility with the polyimide-based resin, has a low refractive index, and easily forms a film having high hardness.

Examples of the acryl-based resin include poly(meth)acrylic acid esters such as polymethyl methacrylate, methyl methacrylate-(meth)acrylic acid copolymers, methyl methacrylate-(meth)acrylic acid ester copolymers, methyl methacrylate-acrylic acid ester-(meth)acrylic acid copolymers, and methyl(meth)acrylate-styrene copolymers. The acryl-based resin may have a glutarimide structural unit or a lactone ring structural unit introduced through modification.

From the viewpoint of transparency, compatibility with the polyimide-based resin, and mechanical strength, the acryl-based resin may have methyl methacrylate as a main structural unit. The amount of methyl methacrylate with respect to the amount of all monomer components in the acryl-based resin may be 60 wt % or more, 70 wt % or more, 80 wt % or more, 85 wt % or more, 90 wt % or more, or 95 wt % or more. The acryl-based resin may be a homopolymer of methyl methacrylate. The acryl-based resin may be obtained by introducing a glutarimide structure or a lactone ring structure into an acryl-based polymer having a methyl methacrylate content in the above range.

From the viewpoint of the heat resistance of the transparent resin film, the glass transition temperature of the acryl-based resin may be 100° C. or higher, 110° C. or higher, 115° C. or higher, or 120° C. or higher.

From the viewpoint of solubility in an organic solvent, compatibility with the polyimide-based resin, and film strength, the weight-average molecular weight of the acryl-based resin (in terms of polystyrene) may be 5,000 to 500,000, 10,000 to 300,000, or 15,000 to 200,000.

From the viewpoint of the heat stability and light stability of the film, it is preferable that the content of reactive functional groups such as ethylenically unsaturated groups and carboxy groups in the acryl-based resin is small. The iodine value of the acryl-based resin may be 10.16 g/100 g (0.4 mmol/g) or less, 7.62 g/100 g (0.3 mmol/g) or less, or 5.08 g/100 g (0.2 mmol/g) or less. The iodine value of the acryl-based resin may be 2.54 g/100 g (0.1 mmol/g) or less, or 1.27 g/100 g (0.05 mmol/g) or less. The acid value of the acryl-based resin may be 0.4 mmol/g or less, 0.3 mmol/g or less, or 0.2 mmol/g or less. The acid value of the acryl-based resin may be 0.1 mmol/g or less, 0.05 mmol/g or less, or 0.03 mmol/g or less. A small acid value tends to lead to enhancement of the stability of the acryl-based resin and improvement of compatibility with the polyimide-based resin.

### <Composition of Transparent Resin Film>

As described above, the transparent resin film contains, as resin components, a polyimide-based resin and OTHER resin. The ratio between the polyimide-based resin and the OTHER resin in the transparent resin film is not particularly limited. The mixing ratio (weight ratio) of the polyimide-based resin and the OTHER resin may be 98:2 to 2: 98, 95:5 to 10:90, 90:10 to 15:85, or 65:35 to 50:50. When the ratio of the polyimide-based resin is high, the elastic modulus and the pencil hardness of the film tends to increase, resulting in excellent mechanical strength. A higher ratio of the OTHER resin tends to lead less coloring of the film, higher total light transmittance, lower yellowness index (YI), and higher transparency.

To sufficiently exhibit the effect of improving the transparency by mixing the polyimide-based resin and the OTHER resin, the ratio of the OTHER resin based on the total of the polyimide-based resin and the OTHER resin may be 10 to 90 wt %, 15 to 85 wt %, 20 to 80 wt %, 30 to 70 wt %, 35 to 65 wt %, or to 60 wt %.

In addition to the resin components, the transparent resin film may contain an organic or inorganic low-molecular-weight compound or the like. The transparent resin film may contain, as an additive, a bluing agent, an ultraviolet absorber, a flame retardant, a stabilizer, a crosslinking agent, a surfactant, a leveling agent, a plasticizer, fine particles, or the like.

For the purpose of improving blocking resistance, adjusting a refractive index, and the like, the transparent resin film may contain organic fine particles such as polystyrene and a crosslinked acryl-based resin, and inorganic fine particles such as silica and a layered silicate. However, blending fine particles may cause a decrease in transmittance and an increase in haze of the film. In particular, silicon oxide such as silica is useful for reducing the refractive index of the film, but is likely to cause poor dispersion in the resin matrix, and is likely to cause deterioration in transparency, mechanical strength, and bending resistance. Thus, the content of the silicon oxide may be 5 parts by weight or less, 1 part by weight or less, 0.5 parts by weight or less, or 0.1 parts by weight or less, or may be 0 with respect to 100 parts by weight of the total of the resin components.

### <Production of Transparent Resin Film>

Although the method for forming the transparent resin film is not particularly limited, a solution method is preferable in which an above solution containing the polyimide-based resin and the OTHER resin is applied onto a support, and the solvent is then dried and removed.

The solvent is not particularly limited as long as it exhibits solubility to both the polyimide-based resin and the OTHER resin. Examples of the solvent include amide-based solvents such as N,N-dimethylformamide, N,N-dimethylacetamide and N-methyl-2-pyrrolidone; ether-based solvents such as tetrahydrofuran and 1,4-dioxane; ketone-based solvents such as acetone, methyl ethyl ketone, methyl propyl ketone, methyl isopropyl ketone, methyl isobutyl ketone, diethyl ketone, cyclopentanone, cyclohexanone, and methyl cyclohexanone; and halogenated alkyl solvents such as chloroform, 1,2-dichloroethane, 1,1,2,2-tetrachloroethane, chlorobenzene, dichlorobenzene, and methylene chloride. Of these, a ketone-based solvent and an alkyl halide-based solvent are preferable because the polyimide resin or the like has excellent solubility in the solvents, the solvents have a low boiling point, and the residual of the solvents at the time of film production can be easily removed.

As a method for applying the resin solution onto a support, a known method using a bar coater, a comma coater or the like can be applied. As the support, a glass substrate, a metal substrate, a metal drum or a metal belt made of SUS or the like, a plastic film, or the like can be used. From the viewpoint of improving productivity, it is preferable to produce a film by a roll-to-roll process using an endless support such as a metal drum or a metal belt, a long plastic film or the like as a support. When a plastic film is used as the support, a material that is not soluble in the solvent of the resin solution (dope) may be appropriately selected.

Heating may be performed when the solvent is dried. The heating temperature is not particularly limited as long as the solvent can be removed, and coloring of the resulting film can be suppressed, and the temperature may be appropriately set to room temperature to about 250° C., or 50° C. to 220° C. The heating temperature may be elevated stepwise. To enhance the solvent removal efficiency, the resin film may be peeled off from the support and dried after the drying proceeds to some extent. Drying can be performed in an air atmosphere or a nitrogen atmosphere. To promote the removal of the solvent, heating may be performed under reduced pressure.

For the purpose of, for example, improving the mechanical strength of the film, the film may be stretched in one direction or a plurality of directions. When the film is stretched, polymer chains are aligned along the stretching direction, and thus, the strength in an in-plane direction of the film is improved, and the occurrence of breaking and cracking of the film tends to be suppressed, and dent recoverability tends to be improved.

Although a film made of an acryl-based resin alone may have low toughness, strength of a film may be improved by employing a system in which a polyimide-based resin and an acryl-based resin are compatible with each other. In addition, when a compatible film of a polyimide-based resin and an acryl-based resin is stretched, the tensile modulus in the stretching direction tends to increase, and accordingly, the bending resistance tends to improve.

For example, a film used as a cover window material or a substrate material for a foldable display device is repeatedly bent along a bending axis at the same position. Such a film is required to have high mechanical strength in a direction perpendicular to the bending axis. Thus, by disposing the film such that the stretching direction of the film is perpendicular to the bending axis, the film is hardly broken or cracked at the bent portion even though bending is repeated, and a device having high bending resistance can be provided.

Stretching conditions of the film are not particularly limited. For example, the stretching temperature is about ±40° C. of the glass transition temperature of the film, and the temperature may be about 120 to 300° C., 150 to 250° C., or 180 to 230° C. The stretching ratio is about 1 to 200%, and it may be to 150%, 10 to 120%, or 20 to 100%. The tensile modulus in the stretching direction tends to increase as the stretching ratio increases. On the other hand, when the stretching ratio is excessively large, the mechanical strength in the direction perpendicular to the stretching direction tends to decrease, and the handleability of the film may decrease.

From the viewpoint of enhancing the strength in all directions in the film plane, the film may be biaxially stretched. The biaxial stretching may be simultaneous biaxial stretching or sequential biaxial stretching. In the biaxial stretching, the stretching ratio in one direction and the stretching ratio in a direction perpendicular to the one direction may be the same or different. When a stretching ratio in one direction is different from a stretch direction in another direction, the mechanical strength in a direction in which the stretching ratio is larger tends to be relatively large. When a biaxially stretched film having anisotropy in stretching ratio is used for a foldable device, it is preferable to dispose the biaxially stretched film such that a direction in which the stretching ratio is relatively larger comes to a direction perpendicular to the bending axis.

The thickness of the transparent resin film is not particularly limited, and may appropriately be set according to the intended use of the transparent film. The thickness of the transparent resin film is, for example, 5 to 300 μm. The thickness of the transparent resin film may be 10 to 100 μm, 15 to 80 μm, 20 to 55 μm, or 25 to 55 μm from the viewpoint of achieving both self-support and flexibility and providing a highly transparent film. When the film is stretched, the thickness after stretching may be within the above range.

### <Properties of Transparent Resin Film>

It is preferable that the transparent resin film has a single glass transition temperature in differential scanning calorimetry (DSC) and/or dynamic mechanical analysis (DMA). When the polyimide-based resin and another resin contained in the transparent resin film exhibit compatibility, the transparent film has a single glass transition temperature.

The haze of the transparent resin film may be 10% or less, 5% or less, 4% or less, 3.5% or less, 3% or less, 2% or less, 1% or less, or 0.5% or less. When the transparent resin film contains a polyimide-based resin and OTTER resin, low haze can be achieved by using a resin having high compatibility with the polyimide-based resin such as an acryl-based resin as OTHER resin.

The total light transmittance of the transparent resin film may be 90.0% or more, 90.5% or more, 91.0% or more, or 91.5% or more. As the total light transmittance is higher, the white luminance of the display is higher, and the display is superior in visibility. As described above, mixing the polyimide-based resin with the OTHER resin tends to lower the refractive index and increase the total light transmittance as compared with the case of the polyimide-based resin alone.

The yellowness index (YI) of the transparent resin film may be 3.0 or less, 2.0 or less, or 1.0 or less. The yellowness index (YI) of the transparent resin film may be −3.0 or more, −2.0 or more, or −1.0 or more. By mixing the polyimide-based resin with the OTHER resin such as an acryl-based resin, a film is obtained which is less colored and has smaller absolute value of YI as compared to a case where the polyimide-based resin is used alone.

The refractive index of the transparent resin film may be 1.600 or less. The refractive index of the transparent resin film may be 1.580 or less, 1.560 or less, 1.540 or less, or 1.520 or less. The refractive index of a film containing only a polyimide-based resin as the resin component is typically higher than 1.600, and light reflection due to a difference in refractive index from an air interface or an interface with another member is large (reflectance is high), and thus light transmittance is small. Since the mixed-resin of the polyimide-based resin and the OTHER resin has a lower refractive index than the case of the polyimide-based resin alone, light reflection at the interface is reduced, and the total light transmittance is increased. In particular, since an acryl-based resin has a low refractive index, when an acryl-based resin is used as the OTHER resin, the transparent resin film tends to have a low refractive index and a high total light transmittance.

Since a stretched film tends to have a large refractive index in the stretching direction (alignment direction of polymer chains), the film may have in-plane refractive index anisotropy when the transparent resin film is a stretched film. The transparent resin film may have an in-plane refractive index difference (a difference between the maximum refractive index and the minimum refractive index in the plane) of 0.005 or more, 0.010 or more, 0.020 or more, or 0.030 or more. When the transparent resin film has refractive index anisotropy, the average value of the maximum in-plane refractive index (generally, the refractive index in the stretching direction) and the minimum in-plane refractive index may be in the above range.

The tensile modulus of the transparent resin film may be 3.0 GPa or more, 3.5 GPa or more, 4.5 GPa or more, 5.0 GPa or more, 5.5 GPa or more, or 6.0 GPa or more. The larger the tensile modulus is, the better the mechanical strength, such as hardness or bending resistance, tends to be.

The transparent resin film may have in-plane anisotropy in tensile modulus. When the transparent resin film is a stretched film, the tensile modulus in the stretching direction tends to be larger than the tensile modulus in a direction perpendicular to the stretching direction. When the transparent resin film is a biaxially stretched film or a fixed-end uniaxially stretched film, the tensile modulus in all directions in the plane may be larger than that before stretching. When the transparent resin film has in-plane anisotropy of tensile modulus, the maximum in-plane tensile modulus (generally, tensile modulus in the stretching direction) may be in the above range.

When the transparent resin film has anisotropy of tensile modulus, the tensile modulus in the direction in which the tensile modulus is maximized (generally, the direction in which the stretching ratio is large) may be 4.0 GPa or more, 4.5 GPa or more, or 5.0 GPa or more. The difference between the maximum value and the minimum value of the in-plane tensile modulus may be 0.5 GPa or more, 1.0 GPa or more, or 1.3 GPa or more. When the transparent resin film has anisotropy of tensile modulus, the larger the difference between the maximum value and the minimum value of the in-plane tensile modulus is, the better the dent recoverability may be. The factor for the fact that the dent recoverability is improved by the large anisotropy of the tensile modulus is estimated to be that the recoverability with respect to a dent is imparted by the balance between the resistance to a dent due to a high elastic modulus and the flexibility due to a relatively low elastic modulus in the direction perpendicular thereto.

### [Hard Coat Layer]

The transparent film 5 may be one consisting only of the transparent resin film 1, or may be provided as a laminate including various functional layers on one or both principal surfaces. Examples of the functional layer include a hard coat layer, an ultraviolet absorbing layer, an adhesive layer, a refractive index adjusting layer, and an easily bonding layer. When a laminate of a thin glass and a transparent film is applied to a cover window material of a display, the transparent film 5 may have a hard coat layer 3 on a surface of the transparent resin film 1 opposite from the thin glass 7. The configuration in which the hard coat layer is provided on the surface of the transparent resin film improves the scratch resistance and the hardness of the laminate.

The material constituting the hard coat layer is not particularly limited as long as it has a function of preventing generation of scratches, and examples thereof include polyester-based resins, acryl-based resins, urethane-based resins, amide-based resins, siloxane-based resins and epoxy-based resins. Of these, an acryl-based hard coat layer which is a cured product of an acryl-based hard coat resin composition or a siloxane-based hard coat layer which is a cured product of a siloxane-based hard coat resin composition is preferable from the viewpoint of preventing generation of scratches.

### <Acryl-Based Hard Coat Material>

The acryl-based hard coat material contains a monomer or oligomer having a (meth)acryloyl group in the molecule as a curable resin component. The molecular weight of the acrylic monomer or oligomer is, for example, about 200 to 10,000. The acryl-based hard coat material can control hardness, scratch resistance, bending resistance, optical characteristics, and the like by combining a plurality of monomers or oligomers having a (meth)acryloyl group. From the viewpoint of curability in photoradical polymerization, the hard coat material may have an acryloyl group.

Specific examples of the oligomer having a (meth)acryloyl group include urethane (meth)acrylate, polyester (meth)acrylate, and epoxy (meth)acrylate. The oligomer may have two or more (meth)acryloyl groups in one molecule. The molecular weight of the oligomer may be 10,000 or less.

Examples of the acrylic monomer include compounds having one (meth)acryloyl group, such as methyl (meth)acrylate and 2-ethylhexyl (meth)acrylate; compounds having two (meth)acryloyl groups in one molecule, such as ethylene glycol di(meth)acrylate, polyethylene glycol di(meth)acrylate, propylene glycol di(meth)acrylate, polypropylene glycol di(meth)acrylate, 1,4-butanediol di(meth)acrylate, 1,3-butylene glycol di(meth)acrylate, and 1,6-hexanediol di(meth)acrylate; and compounds having three or more (meth)acryloyl groups in one molecule, such as glycerin tri(meth)acrylate, trimethylolpropane tri(meth)acrylate, ditrimethylolpropane tetra(meth)acrylate, pentaerythritol tri(meth)acrylate, pentaerythritol tetra(meth)acrylate, dipentaerythritol tetra(meth)acrylate, dipentaerythritol penta(meth)acrylate, and dipentaerythritol hexa(meth)acrylate.

From the viewpoint of enhancing the scratch resistance of the hard coat layer, the acryl-based hard coat material may contain a tri- or more polyfunctional (meth)acrylate. The functional group equivalent of the (meth)acryloyl group of the polyfunctional (meth)acrylate, that is, the molecular weight per (meth)acryloyl group may be 80 to 150 g/eq. Among the polyfunctional (meth)acrylates recited as examples above, dipentaerythritol hexa(meth)acrylate is particularly preferable.

### <Siloxane-Based Hard Coat Material>

The siloxane-based hard coat material contains a curable compound having a siloxane bond as a curable resin component. From the viewpoint of resistance to scratches, the siloxane-based curable compound may have an epoxy group as a polymerizable functional group, and in particular, a polyorganosiloxane compound containing an alicyclic epoxy group is preferable. Such siloxane-based hard coat materials are disclosed in WO 2014/204010 A, WO 2018/096729 A, WO 2020/040209 A, and the like, and these descriptions can be referred to and incorporated.

Since a siloxane-based hard coat material having an alicyclic epoxy group as a polymerizable functional group has small curing shrinkage during curing, curling and cracking are less likely to occur even when the thickness of the hard coat layer is increased. Since the thickness of the hard coat layer can be made large, it is advantageous for improving the dent resistance and the dent recoverability.

A polyorganosiloxane compound having an alicyclic epoxy group is obtained by condensation of a silane compound of general formula (1).

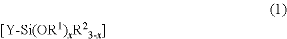

In the general formula (1), R¹ is a hydrogen atom or an alkyl group having 1 to 10 carbon atoms. Specific examples of the alkyl group include a methyl group, an ethyl group, a propyl group, a butyl group, a pentyl group, a hexyl group, a heptyl group, an octyl group, a nonyl group, a decyl group, an isopropyl group, an isobutyl group, a cyclohexyl group, and an ethylhexyl group.

The silane compound represented by general formula (1) has two or three (—OR¹)s in one molecule. Since Si—OR¹ is hydrolyzable, a polyorganosiloxane compound is obtained by condensation of a silane compound. From the viewpoint of hydrolyzability, the number of carbon atoms in R¹ may be 3 or less, and R¹ may be a methyl group.

In the general formula (1), R² is a hydrogen atom, or a monovalent hydrocarbon group selected from the group consisting of an alkyl group having 1 to 10 carbon atoms, an aryl group having 6 to 25 carbon atoms, and an aralkyl group having 7 to 12 carbon atoms. Specific examples of the hydrocarbon group include a methyl group, an ethyl group, a propyl group, a butyl group, a pentyl group, a hexyl group, a heptyl group, an octyl group, a nonyl group, a decyl group, an isopropyl group, an isobutyl group, a cyclohexyl group, an ethylhexyl group, a benzyl group, a phenyl group, a tolyl group, a xylyl group, a naphthyl group, and a phenethyl group.

In the general formula (1), x is 2 or 3, and when x=3 (that is, when three alkoxy groups (or hydroxy groups) —OR¹ are bonded to the Si atom), the silane compound does not have R². From the viewpoint of forming a net-shaped polyorganosiloxane compound, and increasing the number of epoxy groups contained in the polyorganosiloxane compound to increase the hardness of a cured film, it is preferable that x=3 in the general formula (1). A silane compound with x=2 and a silane compound with x=3 may be used in combination. A silane compound with x being 1 may be used in addition to the silane compound with x being 2 or 3 for the purpose of, for example, adjusting the molecular weight of the polyorganosiloxane compound to be obtained via condensation.

In the general formula (1), Y is a monovalent organic group containing an alicyclic epoxy group. Examples of Y include an alicyclic epoxy group, an alkyl group having an alicyclic epoxy group as a substituent, and an alkylene glycol group having an alicyclic epoxy group as a substituent. From the viewpoint of heat resistance and bending resistance, the alkyl group having an alicyclic epoxy group as a substituent is preferable.

Specific examples of the alkyl group having an alicyclic epoxy group as a substituent include a (3,4-epoxycyclohexyl)methyl group, a 2-(3,4-epoxycyclohexyl)ethyl group, a 3-(3,4-epoxycyclohexyl)propyl group, a 4-(3,4-epoxycyclohexyl)butyl group, a 5-(3,4-epoxycyclohexyl)pentyl group, a 6-(3,4-epoxycyclohexyl)hexyl group, a 7-(3,4-epoxycyclohexyl)heptyl group, an 8-(3,4-epoxycyclohexyl)octyl group, a 9-(3,4-epoxycyclohexyl)nonyl group, a 10-(3,4-epoxycyclohexyl)decyl group, a 11-(3,4-epoxycyclohexyl)undecyl group, and a 12-(3,4-epoxycyclohexyl)dodecyl group.

Specific examples of the silane compound represented by the general formula (1) include (3,4-epoxycyclohexyl)trimethoxysilane, (3,4-epoxycyclohexyl)methyldimethoxysilane, (3,4-epoxycyclohexyl)dimethylmethoxysilane, (3,4-epoxycyclohexyl)triethoxysilane, (3,4-epoxycyclohexyl)methyldiethoxysilane, (3,4-epoxycyclohexyl)dimethylethoxysilane, {(3,4-epoxycyclohexyl)methyl}trimethoxysilane, {(3,4-epoxycyclohexyl)methyl}methyldimethoxysilane, {(3,4-epoxycyclohexyl)methyl}dimethylmethoxysilane, {(3,4-epoxycyclohexyl)methyl}triethoxysilane, {(3,4-epoxycyclohexyl)methyl}methyldiethoxysilane, {(3,4-epoxycyclohexyl)methyl}dimethylethoxysilane, {2-(3,4-epoxycyclohexyl)ethyl}trimethoxysilane, {2-(3,4-epoxycyclohexyl)ethyl}methyldimethoxysilane, {2-(3,4-epoxycyclohexyl)ethyl}dimethylmethoxysilane, {2-(3,4-epoxycyclohexyl)ethyl}triethoxysilane, {2-(3,4-epoxycyclohexyl)ethyl}methyldiethoxysilane, and {2-(3,4-epoxycyclohexyl)ethyl}dimethylethoxysilane. Among them, 2-(3,4-epoxycyclohexyl)ethyltrimethoxysilane is preferable from the viewpoint of ease of a condensation reaction and hardness of a cured product.

The polyorganosiloxane compound as a condensate of the silane compound may be a condensate of the silane compound of the general formula (1) and another silane compound.

By reacting the above silane compound with water, the Si—OR¹ portion of the silane compound is hydrolyzed, the hydrolyzate is condensed to form a Si—O—Si linkage, and a condensate of a silane compound having an alicyclic epoxy group (a polyorganosiloxane compound) is generated.

From the viewpoint of increasing the hardness of a cured film (a hard coat layer), the weight average molecular weight of the polyorganosiloxane compound may be 500 or more. From the viewpoint of suppressing volatilization, the weight average molecular weight of the polyorganosiloxane compound may be 500 or more. On the other hand, when the molecular weight is excessively large, cloudiness may occur due to, for example, a decrease in compatibility with other components in the composition. Therefore, the weight average molecular weight of the polyorganosiloxane compound may be 20000 or less.

### <Polymerization Initiator>

Preferably, the hard coat composition contains a polymerization initiator in addition to the above-described curable resin components. The polymerization initiator may be a photopolymerization initiator.

The acryl-based hard coat composition containing a compound having a (meth)acryloyl group as a curable resin component may contain a photoradical polymerization initiator that generates radicals by light. The siloxane-based hard coat composition containing a polyorganosiloxane compound having an epoxy group as a curable resin component may contain a photoacid generator (photocationic polymerization initiator) that generates an acid by light.

Examples of the photoradical polymerization initiator include 2,2-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzyldimethylketal, N,N,N,N-tetramethyl-4,4′-diaminobenzophenone, 1-(4-isopropylphenyl)-2-hydroxy-2-methylpropan-1-one, and other thioxanthone-based compounds.

Examples of the photoacid generator include onium salts in which an anion (a strong acid), such as antimony hexafluoride, boron tetrafluoride, phosphorus hexafluoride, phosphorus fluoroalkylfluoride, and gallium fluoroalkylfluoride, and a cation, such as sulfonium, ammonium, phosphonium, iodonium, and selenium, are combined; iron-allene complexes; silanol-metal chelate complexes; sulfonic acid derivatives such as disulfones, disulfonyldiazomethanes, disulfonylmethanes, sulfonylbenzoylmethanes, imidesulfonates and benzoinsulfonates; and organic halogen compounds.

### <Other Components Constituting Hard Coat Composition>

The hard coat composition for forming the hard coat layer may contain a solvent and various types of additive in addition to the curable resin component and the polymerization initiator. Examples of the additive include a leveling agent such as a fluorine-based or silicone-based leveling agent, a sensitizer, a reactive diluent, fine particles, a filler, a dispersant, a plasticizer, an ultraviolet absorber, a surfactant, an antioxidant, a colorant, and a viscosity modifier.

### <Formation of Hard Coat Layer>

The hard coat composition is applied onto the transparent resin film 1, the solvent is dried and removed as necessary, and then the resulting material is cured, whereby the hard coat layer 3 is formed. Examples of the method for applying the hard coat composition include roll coating such as bar coating, gravure coating, and comma coating, die coating such as slot die coating and fountain die coating, spin coating, spray coating, and dip coating. Before application of the hard coat composition, the surface of the transparent resin film 1 may be subjected to surface treatment such as corona treatment or plasma treatment. In addition, an easily adhesive layer or the like may be provided on the surface of the transparent resin film 1.

When the hard coat composition is subjected to an active energy ray irradiation or heating, active species such as an acid and a radical are generated from the photopolymerization initiator, and the curable resin component of the hard coat composition is cured. From the viewpoint of curing reactivity, it is preferable that the curable resin composition contains a photopolymerization initiator and is cured by irradiation with an active energy ray. Examples of the active energy ray applied during photocuring include visible light rays, ultraviolet rays, infrared rays, X-rays, α-rays, β-rays, γ-rays and electron beams. An ultraviolet ray is preferable as the active energy ray due to its high curing reaction rate and excellent energy efficiency. The integral dose of the active energy rays is, for example, about 50 to 10000 mJ/cm², and may be set according to the type and the amount of the photocationic polymerization initiator, the thickness of the hard coat layer, and the like. The curing temperature is not particularly limited, and is typically 150° C. or lower.

The thickness of the hard coat layer 3 may be 1 to 50 μm, 3 μm or more, or 5 μm or more. There is a tendency that as the thickness of the hard coat layer is larger, the pencil hardness, the dent recoverability, and the scratch resistance are improved. On the other hand, when the thickness of the hard coat layer is excessively large, the bending resistance is deteriorated. Therefore, the thickness of the hard coat layer may be 40 μm or less, 30 μm or less, or 25 μm or less.

### [Transparent Adhesive Layer]

In the laminate 10 including the transparent film 5 provided on the thin glass 7, the thin glass 7 and the transparent film 5 (the transparent resin film 1) may be in direct contact with each other, or the thin glass 7 and the transparent film 5 may be bonded together with an appropriate transparent adhesive layer 9 interposed therebetween. When the thin glass 7 and the transparent film 5 are bonded together with the transparent adhesive layer 9 interposed therebetween, the bending resistance and the flexibility exhibited when the laminate 10 is bent tend to be improved by the stress relaxation action of the transparent adhesive layer 9.

The material constituting the transparent adhesive layer 9 is not particularly limited as long as it is transparent, and various adhesives and pressure-sensitive adhesives can be applied. Examples of the adhesive include a solvent type adhesive, a reaction type adhesive that reacts and cures by heat or an active energy ray, and a hot melt type adhesive. Examples of the material of the pressure sensitive adhesives include (meth)acryl-based resins, urethane-based resins, silicone-based resins, cross-linked rubbers, and thermoplastic elastomers. Among them, (meth)acryl-based resins are preferable from the viewpoint of transparency and weather resistance.

The transparent adhesive layer 9 may be an adhesive layer made of an adhesive or a pressure sensitive adhesive formed in advance into a film shape, because the thickness between the transparent film and the thin glass 7 can be kept constant. In particular, a double-sided pressure-sensitive adhesive sheet is preferable because it does not require a curing reaction and can be used for adhesion as it is. The double-sided pressure-sensitive adhesive sheet may be a substrate-equipped pressure-sensitive adhesive sheet in which a pressure sensitive adhesive layer is disposed on both surfaces of a transparent substrate film, or may be a substrate-less pressure-sensitive adhesive sheet consisting only of a pressure-sensitive adhesive layer. From the viewpoint of transparency and thickness reduction, a substrate-less pressure-sensitive adhesive sheet is preferable. Examples of the substrate-less pressure-sensitive adhesive sheet include a transparent pressure-sensitive adhesive tape for optical use called an optical clear adhesive (OCA).

The thickness of the transparent adhesive layer may be 5 μm or more, 10 μm or more, or 20 μm or more, and 500 μm or less, 100 μm or less, or 50 μm or less. When the thickness is small, adhesiveness may be insufficient, and when the thickness is excessively large, bending resistance and flexibility of the laminate may be insufficient. From the viewpoint of imparting stress relaxation performance when the laminate is bent, the storage modulus of the transparent adhesive layer at a temperature of 25° C. and a frequency of 1 Hz may be 1×10⁴ Pa or less, or 5×10⁵ Pa or less.

### [Laminate]

In a laminate 10 in which a transparent film 5 is bonded onto a thin glass 7, the transparent film 5 has a function of preventing scattering of glass pieces when the thin glass 7 is broken. The transparent film (the transparent resin film 1) is superior in bending resistance to glass.

Although the overall thickness of the laminate 10 (the total thickness of the thin glass 7, the transparent adhesive layer 9 and the transparent film 5) is not particularly limited, the overall thickness may be 50 μm or more, 80 μm or more, 90 μm or more, 100 μm or more, or 110 μm or more from the viewpoint of improving the impact resistance and the dent recoverability. From the viewpoint of foldability, the overall thickness of the laminate 10 may be 200 μm or less, or 180 μm or less.

The yellowness index (YI) of the laminate 10 may be −3.0 to 3.0 or less, −2.0 to 2.0, or −1.0 to 1.0. It is preferable that the absolute value of YI is small from the viewpoint of improving the visibility of a display and improving the color tone.

The haze of the laminate 10 may be 1% or less, 0.7% or less, or 0.5% or less. The total light transmittance of the laminate 10 may be 90.5% or more, 90.8% or more, 91.0% or more, or 91.5% or more.

Since a polyimide-based transparent resin film is higher in mechanical strength than a transparent resin film of polyethylene terephthalate or the like, a laminate including a polyimide-based transparent resin film disposed on a thin glass is superior in impact resistance and dent recoverability. On the other hand, since transparent polyimide is slightly colored in yellow, the polyimide-based transparent resin film tends to have a large YI. By adopting a blend system of a polyimide-based resin and OTHER resin such as an acryl-based resin as the transparent resin film 1, coloring can be reduced and YI can be reduced.

In addition, since the polyimide-based resin has a high refractive index and a high reflectance at the interface between the film and air, and the interface between the film and the hard coat layer, the polyimide-based transparent resin film has a low total light transmittance. Blending of a polyimide-based resin and OTHER resin such as an acryl-based resin reduces the refractive index and reduces the reflectance at the interface, so that the total light transmittance is increased.

The laminate 10 in which the transparent film 5 is bonded onto the thin glass 7 may have a characteristic that a dent generated by an external force applied on the surface of the transparent film 5 becomes shallow with time, and eventually, the dent disappears and the laminate has returns to its original shape (dent recoverability). The dent recoverability is evaluated by scratching the surface of the laminate located on the transparent film side under the conditions of a load of 750 gf and a speed of 60 mm/min using a pencil having a prescribed hardness for use in a pencil hardness test to generate a dent, and examining whether or not the dent disappears after 24 hours. When a dent observed immediately after the test is no longer observed after 24 hours, it is determined that the sample has the dent recoverability for that hardness. The pencil hardness with which the laminate 10 has dent recoverability may be H or more, 2H or more, 3H or more, or 4H or more.

Since the transparent resin film 1 constituting the transparent film 5 contains a polyimide-based resin, the laminate 10 in which the transparent film 5 is bonded onto the thin glass 7 has high dent recoverability due to superior mechanical strength derived from polyimide. When the transparent film 5 has a hard coat layer 3 on the transparent resin film 1, the dent recoverability tends to be improved.

When the transparent resin film 1 is a blended resin film of a blended resin composed of a polyimide-based resin and OTHER resin such as an acryl-based resin, the transparent resin film 1 tends to have superior dent recoverability as compared with the case of using a transparent resin film of the polyimide-based resin alone. In the blend system of the polyimide-based resin and the OTHER resin, it is considered that imparting appropriate flexibility by the OTHER resin, an action of external force absorption due to intermolecular interaction between polymers of the polyimide-based resin and the OTHER resin, and the like contribute to the improvement in dent recoverability.

The laminate 10 may have bending resistance and is less prone to be broken or cracked by bending. It is preferable that the laminate 10 is not broken or cracked after the operations of bending the laminate 1800 at a radius of 10 mm with the transparent film 5 facing inward and then returning the laminate to the original flat state.

The laminate of one or more embodiments of the present invention is superior in transparency and bending resistance, and also has recoverability of a dent generated by an external force, and thus can be suitably used as a cover window disposed on a surface of an image display panel. In a flexible display device with a touch sensor, a cover window superior in dent recoverability easily recovers deformation such as a dent caused by pressing with a nail, a touch pen, or the like, so that visibility of a display is improved and the cover window can contribute to enhancement of commercial value.

### EXAMPLES

Hereinafter, one or more embodiments of the present invention will be described more specifically based on Examples and Comparative Examples, but the present invention is not limited to the following Examples. Hereinafter, a casting direction at the time of application is referred to as MD, and a direction perpendicular to MD direction is referred to as TD.

### [Preparation of Polyimide Resin]

Dimethylformamide (DMF) was added into a separable flask and stirred in a nitrogen atmosphere. Diamine and tetracarboxylic dianhydride were added thereto at the proportions (mol %) shown in Table 1, and the mixture was stirred for 5 to 10 hours under a nitrogen atmosphere to react, whereby a polyamic acid solution having a solid content concentration of 18 wt % was obtained.

To 100 g of the polyamic acid solution, 5.5 g of pyridine as an imidization catalyst was added, and completely dispersed, 8 g of acetic anhydride was then added, and the mixture was stirred at 90° C. for hours. The solution was cooled to room temperature, and 100 g of 2-propyl alcohol (IPA) was then added dropwise at a rate of 2 to 3 drops/sec while the solution was stirred, whereby a polyimide was precipitated. Further, 150 g of IPA was added, the mixture was stirred for about 30 minutes, and suction filtration was performed with a Kiriyama funnel. The obtained solid was washed with IPA, and then dried in a vacuum oven set at 120° C. for 12 hours, whereby polyimide resins 1 and 2 (PI 1, PI 2) were obtained.

In Table 1, the compounds are abbreviated as follows.

### <Tetracarboxylic Dianhydride>

CBDA: 1,2,3,4-cyclobutanetetracarboxylic acid dianhydride
6FDA: 2,2-bis(3,4-dicarboxyphenyl)−1,1,1,3,3,3-hexafluoropropane dianhydride
TAHMIIBP: bis(1,3-dioxo-1,3-dihydroisobenzofuran-5-carboxylic acid)−2,2′,3,3′,5,5′-hexamethylbiphenyl-4,4′-diyl
ODPA: 4,4′-oxydiphthalic dianhydride

### <Diamine>

TFMB: 2,2′-bis(trifluoromethyl)benzidine
DDS: 3,3′-diaminodiphenylsulfone

TABLE 1

| | Acid dianhydride | | | | Diamine | |
|---|---|---|---|---|---|---|
| | CBDA | 6FDA | TAHMBP | ODPA | TFMB | DDS |
| PI 1 | 30 | 70 | — | — | 100 | — |
| PI 2 | 30 | — | 50 | 20 | 90 | 10 |

### [Production of Transparent Resin Film]

### <Film 1>

The polyimide resin 1 (PI 1) and a commercially available acryl-based resin (“PARAPET G” manufactured by Kuraray Co., Ltd.; methyl methacrylate/methyl acrylate (monomer ratio: 87/13) copolymer, glass transition temperature: 109° C., acid value: 0.0 mmol/g; hereinafter referred to as “acryl-based resin” (Ac)) were dissolved in methylene chloride at a weight ratio of PI 1/Ac=55/45, whereby a solution having a solid content of 11 wt % was prepared. This solution was applied onto an alkali-free glass plate and dried by heating at 60° C. for 15 minutes, 90° C. for 15 minutes, 120° C. for 15 minutes, 150° C. for 15 minutes, and 180° C. for 15 minutes in an air atmosphere, affording a blended resin film having a thickness of about 90 μm.

The obtained film was subjected to fixed-end uniaxial stretching using a stretching machine equipped with a heating oven at a temperature of 205° C. and at a stretching ratio of 80% along TD as the stretching direction (TD length was 1.80 times that of the film before stretching), whereby a stretched film having a thickness of 50 μm was obtained.

### <Film 2>

In preparation of the solution, 5.6 parts by weight of a triazine-based ultraviolet absorber (“ADK STAB LA-31RG” manufactured by ADEKA CORPORATION) and 0.002 parts by weight of an anthraquinone-based bluing agent (“Plast Blue 8590” manufactured by ARIMOTO CHEMICAL Co., Ltd.) were added to 100 parts by weight in total of the polyimide resin and the acryl-based resin, the application thickness was changed such that the thickness after drying was about 55 μm, and the stretching conditions were changed to a stretching temperature of 215° C. and a stretching ratio of 115%. Except for these changes, a stretched film having a thickness of 25 μm was obtained in the same manner as in the preparation of the Film 1.

### <Film 3>

100 parts by weight of the polyimide resin 2 (PI 2), 2.4 parts by weight of a triazine-based ultraviolet absorber (“Tinuvin 477” manufactured by BASF SE), and 0.0065 parts by weight of an anthraquinone-based bluing agent (“Plast Blue 8590” manufactured by ARIMOTO CHEMICAL Co., Ltd.) were dissolved in methylene chloride, whereby a solution having a solid content of 10 wt % was prepared. This solution was applied onto an alkali-free glass plate, and heated and dried at 40° C. for 60 minutes, 80° C. for 30 minutes, 150° C. for 30 minutes, 170° C. for 30 minutes, and 200° C. for 60 minutes in an air atmosphere, affording a transparent polyimide film having a thickness of 50 m.

### <Film 4>

As a Film 4, a commercially available 50 μm-thick biaxially stretched PET film (“Lumirror U48” manufactured by Toray Industries, Inc.) was used.

### [Preparation of Hard Coat Composition]

### <Preparation of Acryl-Based Hard Coat Composition>

To 100 parts by weight of dipentaerythritol hexaacrylate (“ARONIX M-403” manufactured by TOAGOSEI CO., LTD.), 2 parts by weight of a photoradical polymerization initiator (“Omnirad 184” manufactured by IGM Resins) and 0.25 parts by weight of a polyether-modified silicone-based leveling agent (“BYK-300” manufactured by BYK) were added, and propylene glycol monomethyl ether was added as a diluent solvent, whereby an acryl-based hard coat composition having a solid content of 50 wt % was obtained.

### <Siloxane-Based Hard Coat Composition>

A reaction vessel equipped with a thermometer, a stirrer, and a reflux condenser was charged with 66.5 g (270 mmol) of 2-(3,4-epoxycyclohexyl)ethyltrimethoxysilane (“SILQUESTA-186” manufactured by Momentive Performance Materials Inc.) and 16.5 g of 1-methoxy-2-propanol (PGME), and the mixture was homogeneously stirred. To the mixed solution, a solution obtained by dissolving 0.039 g (0.405 mmol) of magnesium chloride as a catalyst in a mixed solution of 9.7 g (539 mmol) of water and 5.8 g of methanol was added dropwise over 5 minutes, and the mixture was stirred to be homogeneous. Thereafter, the solution was heated to 80° C., and a polycondensation reaction was performed for 6 hours with stirring. After completion of the reaction, the solvent and water were distilled off by a rotary evaporator, whereby a condensate of a silane compound (polyorganosiloxane compound) was obtained.

The polystyrene-equivalent weight-average molecular weight measured by GPC apparatus “HLC-8220GPC” (column: TSKgel GMH _{XL}×2 columns, TSKgel G3000H _{XL}, TSKgel G2000H _{XL}) manufactured by TOSOH CORPORATION was 3000. The residual rate of epoxy groups calculated from a ¹H-NMR spectrum measured using deuterated acetone as a solvent with 400 MHz-NMR manufactured by Bruker was 95% or more.

To 100 parts by weight of the polyorganosiloxane compound above, 2 parts by weight of a sulfonium-based photoacid generator (“CPI-101A” manufactured by San-Apro Ltd.) and 0.25 parts by weight of a polyether-modified silicone-based leveling agent (“BYK −300” manufactured by BYK) was added, and propylene glycol monomethyl ether was added as a diluent solvent, whereby a siloxane-based hard coat composition having a solid content of 50 wt % was obtained.

### [Production of Laminate]

### Example 1

A transparent pressure-sensitive adhesive sheet (“8146−1” manufactured by 3M, storage modulus at 25° C. and 1 Hz: 1.2×10⁵ Pa)having a thickness of 25 μm and the Film 1 were sequentially superimposed on one surface of a thin glass having a thickness of 32 m (“Dinorex UTG T2X-1” manufactured by Nippon Electric Glass Co., Ltd., elastic modulus: 70 GPa) and pressed with a rubber roller, whereby a laminate of the thin glass and the Film 1 was produced.

### Example 2

The acryl-based hard coat composition was applied onto one surface of the Film 1 such that the dried thickness was 5 μm, and the solvent was removed at 120° C. Thereafter, the hard coat resin composition was cured by irradiation with ultraviolet rays in a nitrogen atmosphere using a high-pressure mercury lamp such that the integral dose was 1950 mJ/cm², whereby a hard coat film including the acryl-based hard coat layer having a thickness of 5 μm was obtained.

A laminate of a thin glass and a hard coat film was produced in the same manner as in Example except that the above-described hard coat film was used instead of the Film 1. A surface of the hard coat film where no hard coat layer being formed thereon was bonded to the thin glass.

### Example 3

A laminate of a thin glass and a hard coat film was produced in the same manner as in Example except that the thickness of the acryl-based hard coat layer was changed to 10 m.

### Example 4

A laminate of a thin glass and a hard coat film was produced in the same manner as in Example except that the Film 2 was used instead of the Film 1 in the production of the hard coat film.

### Example 5

The siloxane-based hard coat composition was applied onto one surface of the Film 1 with a coater such that the dried thickness was 20 μm, and the solvent was removed at 120° C. Thereafter, the hard coat resin composition was cured by irradiation with ultraviolet rays in a nitrogen atmosphere using a high-pressure mercury lamp such that the integral dose was 1950 mJ/cm², whereby a hard coat film including the siloxane-based hard coat layer having a thickness of 20 μm was obtained. This hard coat film was bonded to a thin glass in the same manner as in Example 2, whereby a laminate of the thin glass and the hard coat film was produced.

### Comparative Example 1

In the same manner as in Example 1 except that a Film 4 (PET film) was used instead of the Film 1, a laminate of a thin glass and the Film 4 was produced.

### Comparative Example 2

A laminate of a thin glass and a hard coat film was produced in the same manner as in Example except that the Film 4 was used instead of the Film 1 in the production of the hard coat film.

### Comparative Example 3

A laminate of a thin glass and a hard coat film was produced in the same manner as in Example except that the Film 3 was used instead of the Film 1 in the production of the hard coat film.

### [Evaluation of Transparent Resin Film]

The Films 1 to 4 were evaluated as follows.

### <Tensile Modulus>

Each film was cut into a strip shape having a width of 10 mm, and allowed to stand at 23° C./55% RH for 1 day to adjust the humidity, and then a tensile test was performed under the following conditions using a tensile tester “AUTOGRAPH AGS-X” manufactured by Shimadzu Corporation to calculate a tensile modulus. The tensile test was performed in each of the MD direction and the TD direction.
Distance between chucks: 100 mm
Tensile speed: 20.0 mm/min
Measurement temperature: 23° C.

### <Refractive Index>

Each film was cut into a 3 cm square, the orientation angle was measured using a retardation measuring apparatus (“OPTIPRO 21−255MA” manufactured by SHINTECH Co., Ltd.), and the direction in which the refractive index was maximized was determined. The Films 1, 2, and 4 had the maximum refractive index in TD, and the Film 3 had the maximum refractive index in MD. A refractive index in the direction in which the maximum refractive index was exhibited (nx) and a refractive index in the direction perpendicular to that direction (ny) were measured with a Prism Coupler (“2010/M” manufactured by Metricon Corporation). The refractive index at a wavelength of 589 nm obtained by performing Cauchy dispersion fitting on the measured values at wavelengths of 404 nm, 594 nm, and 827 nm was taken as the refractive index of the film. From the obtained refractive index, the in-plane average refractive index nₐᵥₑ=(nx+ny)/2 and the in-plane birefringence Δn=nx−ny were calculated.

### [Evaluation of Laminate]

The evaluations described below were performed for the laminates of Examples and Comparative Examples.

### <Total Light Transmittance and Haze>

The total light transmittance and the haze were measured by the methods described in JIS K 7361-1:1999 and JIS K 7136:2000 using a haze meter “HZ-V3” manufactured by Suga Test Instruments Co., Ltd. A D65 light source was used for the measurement.

### <Yellowness Index>

The yellowness index (YI) was measured in accordance with JIS K 7373 using a spectrophotometer SC-P manufactured by Suga Test Instruments Co., Ltd.

### <Dent Recoverability>

A pencil hardness test involving scratching a film surface of a laminate (a surface of a hard coat layer in the case of a hard coat film) with a pencil was performed in accordance with JIS K 5600 under the conditions of a load of 750 gf and a speed of 60 mm/min, and the presence or absence of a dent in the film was observed immediately after the test and 24 hours after the test. 17 types of pencils from 6B to 9H were used as the pencil, and the direction of scratching with the pencil was TD of the transparent resin film. For the presence or absence of a dent, transmitted light and reflected light of the illumination were visually observed under a straight tube type three-wavelength fluorescent lamp illumination, and a sample with which the fluorescent lamp looked distorted at the scratched portion was determined to have a dent.

A scratch test was performed five times (at five locations) with each pencil having an individual hardness, and when no dent was observed at four or more locations (when a dent was observed at one or less locations), it was determined that the tested sample had dent resistance to the hardness of the pencil. In Examples 1 to 3 and 5 and Comparative Examples 1 to 3, the dent resistance (the dent immediately after the test) was determined to be “6B >” (less than 6B) because dents were observed at 2 or more locations when scratched with a 6B pencil. In Example 4, the number of dents when the sample was scratched with a 3B pencil was one or less and the number of dents when the sample was scratched with a 2B pencil was two or more, thus the dent immediately after the test was determined to be “3B”.

For the samples in which dents were observed at two or more locations, the presence or absence of the dents was confirmed again 24 hours after the scratch test, and then, a sample in which the number of dents decreased to one or less, it was determined that the dents were recovered. The highest pencil hardness at which the dents recovered was defined as the dent after 24 hours. In Comparative Examples 1 and 2, since dents did not recover in the sample scratched with a 6B pencil, the dent after 24 hours was determined as “6B >”. For the others, the highest hardness at which the dents recovered was taken as the dent after 24 hours. In Example 1, dents recovered in the samples scratched with 2H to 6B pencils, but scratches were observed on the film surface in all the samples. In Examples 2 to 5 and Comparative Example 3, no scratch was found on the film surface (hard coat layer) in the samples in which dents had recovered.

### <Bending Test (Bending Resistance)>

The laminate was wound 1800 around a cylindrical rod having a radius of 10 mm with the thin glass side of the laminate as an outer surface and the film side as an inner side, and the laminate was bent, then returned to an extended state, and visually confirmed. In none of the laminates of Examples and Comparative Examples, cracks or fracture was observed, and the laminates had good bending resistance.

The configurations of the transparent resin film and the hard coat layer in the laminates of Examples and Comparative Examples, and the evaluation results of the transparent resin films and the laminates are shown in Table 2.

TABLE 2

| | | | | | | | | Com- | Com- | Com- |
|---|---|---|---|---|---|---|---|---|---|---|
| | | | Example | Example | Example | Example | Example | parative | parative | parative |
| | | | 1 | 2 | 3 | 4 | 5 | Example 1 | Example 2 | Example 3 |
| Config- | Transparent | | 1 | | | | 2 | 4 | | 3 |
| uration | resin film | Material | PI 1/Ac | | | | PI 1/Ac | PET | | PI 2 |
| | | Thickness (μm) | 50 | | | | 25 | 50 | | 50 |
| | Hard coat | Material | | Acryl | Acryl | Siloxane | Acryl | | Acryl | Acryl |
| | layer | Thickness (μm) | | 5 | 10 | 20 | 10 | | 5 | 5 |

| | | | | | | | |
|---|---|---|---|---|---|---|---|
| Eval- | Transparent | Refractive | nx | 1.5445 | 1.5505 | 1.6776 | 1.6205 |
| uation | resin film | index | ny | 1.5244 | 1.5265 | 1.6436 | 1.6173 |
| results | | | nₐᵥₑ | 1.5345 | 1.5385 | 1.6606 | 1.6189 |
| | | | Δη | 0.0201 | 0.0239 | 0.0340 | 0.0032 |
| | | Tensile | MD | 3.8 | 3.4 | 5.4 | 5.6 |
| | | modulus | TD | 5.2 | 5.3 | 4.2 | 5.4 |
| | | (GPa) | | | | | |

| | | | | | | | | | |
|---|---|---|---|---|---|---|---|---|---|
| Laminate | TT (%) | 91.7 | 91.8 | 91.8 | 91.9 | 91.9 | 91.6 | 91.6 | 90.1 |
| | Haze(%) | 0.3 | 0.1 | 0.1 | 0.2 | 0.4 | 0.7 | 0.2 | 1.1 |
| | YI (%) | 0.7 | 0.5 | 0.5 | 0.8 | 0.8 | 1.3 | 1.0 | 1.5 |

| | | | | | | | | | |
|---|---|---|---|---|---|---|---|---|---|
| Dent | Immediately | 6B> | 6B> | 6B> | 3B | 6B> | 6B> | 6B> | 6B> |
| | after test | | | | | | | | |
| | After 24 | 2H | 2H | 4H | 4H | 2H | 6B> | 6B> | F |
| | hours | | | | | | | | |

The laminates including the transparent resin films of the blended resins of Examples 1 to 5 each had a high total light transmittance, a low haze, and a low YI, had superior transparency, and further had dent recoverability against scratching with pencils having hardnesses of 211 or more.

In Comparative Example 1, in which a PET film was used as the transparent resin film, dent recoverability was not exhibited even for scratching with a pencil having a hardness of 6B, and the dent recoverability was poor. A result similar to this was also obtained in Comparative Example 2 using a hard coat film having a hard coat layer on a PET film.

The laminate of Comparative Example 3 using the hard coat film having a hard coat layer on a transparent polyimide film was superior in dent recoverability as compared with Comparative Examples 1 and 2, but was inferior in dent recoverability as compared with Examples 1 to 5 using a blended resin film of a transparent polyimide and an acryl-based resin. Since the laminates of Examples 1 to 5 exhibited superior dent recoverability though the Films 1 and 2 used in Examples 1 to 5 had tensile moduli smaller than that of the Film 3 used in Comparative Example 3, it can be said that the dent recoverability tends to be improved by blending of a transparent polyimide and an acryl-based resin.

Comparison between Example 2 and Examples 3 and 4 each using a hard coat film equipping a hard coat layer having a thickness larger than that of Example 2 shows that the larger the thickness of the hard coat layer is, the better the dent recoverability is. On the other hand, taking into consideration the fact that Example 1 in which no hard coat layer was provided on the transparent resin film, has dent recoverability comparable to that of Example 2 and the fact that Example 1 was superior in dent recoverability to Comparative Examples 2 and 3 in which the hard coat layer was provided, it can be said that using a blended resin film as the transparent resin film of laminate greatly contributes to improvement in dent recoverability.

Comparison between Example 3 and Example 5 showed that the larger the thickness of the transparent resin film was, the better the dent recoverability was.

In Examples 1 to 5 in which a blended resin film of a transparent polyimide and an acryl-based resin was used, the total light transmittance of the laminates was 91.7% or more, and the laminates were superior in light transmittance to the laminates of Comparative Examples 1 to 3. It is considered that in the Films 1 and 2 used in Examples 1 to 5, the refractive index and the light reflection at the interface were reduced by blending of a polyimide with an acryl-based resin so that the total light transmittance was improved.

### DESCRIPTION OF REFERENCE SIGNS

1 transparent resin film
3 hard coat layer
5 transparent film (hard coat film)
7 thin glass
9 transparent adhesive layer
10 laminate

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A laminate comprising:
a thin glass having a thickness of 100 μm or less; and
a transparent resin film bonded to one principal surface of the thin glass,
wherein the transparent resin film comprises a polyimide-based resin and a solvent-soluble resin other than the polyimide-based resin.

2. The laminate according to claim 1, wherein the transparent resin film has a refractive index of 1.600 or less.

3. The laminate according to claim 1, wherein the solvent-soluble resin is an acryl-based resin.

4. The laminate according to claim 3, wherein the acryl-based resin comprises methyl methacrylate as a main component.

5. The laminate according to claim 1, wherein:
the polyimide-based resin is a polyimide comprising a structure derived from a tetracarboxylic dianhydride and a structure derived from a diamine,
a fluorine-containing aromatic tetracarboxylic dianhydride and an alicyclic tetracarboxylic dianhydride are comprised as the tetracarboxylic dianhydride, and
a fluorine-containing diamine is comprised as the diamine.

6. The laminate according to claim 1, wherein the transparent resin film is a stretched film.

7. The laminate according to claim 1, wherein the transparent resin film has a thickness of 20 to 55 μm.

8. The laminate according to claim 1, wherein the transparent resin film has a total light transmittance of 90.5% or more.

9. The laminate according to claim 1, wherein a hard coat layer is provided on one principal surface of the transparent resin film.

10. The laminate according to claim 9, wherein the hard coat layer is an acryl-based hard coat layer.

11. The laminate according to claim 9, wherein the hard coat layer is a siloxane-based hard coat layer.

12. The laminate according to claim 9, wherein the hard coat layer has a thickness of 1 to 50 μm.

13. A display including the laminate according to claim 1.
